(19) United States
(12) Patent Application Publication
(10) Pub. No.: US 2024/0289887 A1
(43) Pub. Date: Aug. 29, 2024

(54) AUTOMATED PACKET CREATION BASED ON CLAIM INGESTION AND VALIDATION

(71) Applicants: Nicole Blohm, Mount Pleasant, SC (US); Merlyn Evans, Arlington, VA (US); Ashok Shenoy, Hauppauge, NY (US)

(72) Inventors: Nicole Blohm, Mount Pleasant, SC (US); Merlyn Evans, Arlington, VA (US); Ashok Shenoy, Hauppauge, NY (US)

(73) Assignee: Ricoh Company, Ltd., Tokyo (JP)

(21) Appl. No.: 18/115,529

(22) Filed: Feb. 28, 2023

(51) Int. Cl. G06Q 40/08

(52) U.S. Cl. CPC G06Q 40/08

(57) ABSTRACT

Techniques for automatically creating a packet based on claim ingestion and validation are provided. In one technique, an indication of a receipt of a document is received. In response to receiving the indication, a packet profile that identifies a set of required documents for a claim is identified. A packet is generated based on the packet profile. A particular required document in the set of required documents is identified. Data that associates the document with the particular required document and the packet is stored. The packet is updated to indicate that the particular required document has been received. The packet indicates that one or more required documents, in the set of required documents, that are different than the particular required document, have not been received.

### RELATED APPLICATION DATA

This application is related to U.S. patent application Ser. No. 17/978,970 entitled PROVIDING STRATEGIC RECOMMENDATIONS, LINKS TO ACTIONABLE TASKS, PERFORMANCE PLANNING, AND MEASUREMENTS IN A WORKFLOW, filed Nov. 2, 2022, the contents of which are incorporated by reference in their entirety for all purposes as if fully set forth herein.

This application is also related to U.S. patent application Ser. No. 18/104,217 entitled END-TO-END INTEGRATION OF DISPARATE DATA SYSTEMS IN CLAIMS PROCESSING, filed Jan. 31, 2023, the contents of which are incorporated by reference in their entirety for all purposes as if fully set forth herein.

### TECHNICAL FIELD

This invention relates generally to a claims processing system and, more specifically, to an approach for automatically creating packets of documents through claims ingestion and validation.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Document processing related to claims is a manual and tedious task. Some types of claims require many documents, which may come from many different sources at different times. Some documents related to a single claim may be physical while other documents related to the same claim may be electronic. A set of documents expected for a particular claim need to be collected and considered as a whole in order to make a determination about approving or denying a claim. These issues cause document collection and claim adjudication to be a very manual and time-consuming process. Some claims processing enterprises have reported that one hundred employees spend 30-90 days to process a typical number of claims. Not only is claims processing expensive, delays in claims processing lead to negative customer experience. Furthermore, significant manual intervention leads to many unintended human errors.

### SUMMARY

The appended claims may serve as a summary. In one aspect, an apparatus is provided. The apparatus comprises a memory storing instructions which, when executed by one or more processors, cause automatically receiving an indication of a receipt of a document. Execution also causes, in response to receiving the indication, identifying a packet profile that identifies a set of required documents for a claim; generating a packet based on the packet profile; identifying a particular required document in the set of required documents; storing data that associates the document with the particular required document and the packet; updating the packet to indicate that the particular required document has been received, wherein the packet indicates that one or more required documents, in the set of required documents, that are different than the particular required document, have not been received.

The aforementioned approaches may also be implemented by one or more computer-implemented processes and non-transitory computer-readable media that store instructions which, when processed by one or more processed, implement the approach.

### BRIEF DESCRIPTION OF THE DRAWINGS

In the figures of the accompanying drawings like reference numerals refer to similar elements.

FIG. 1 is a flow diagram that depicts a claims management process, in an embodiment;

FIG. 2 is a block diagram that depicts an example integrated claims processing system, in an embodiment;

FIG. 3 is a block diagram that depicts components of an example packet generator, in an embodiment;

FIGS. 4A-C are screenshots of example user interfaces that display information about one or more claims, in an embodiment;

FIG. 5 is a flow diagram that depicts an example process for processing an electronic document during a claims management process, in an embodiment;

FIG. 6 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. CLAIMS MANAGEMENT PROCESS
III. CLAIMS PROCESSING SYSTEM
IV. AUTOMATED PACKET GENERATION
   A. DOCUMENT RECEIVER
   B. PACKET
   C. PACKET PROFILE
   D. NEW CLAIM DETERMINATION
   E. DOCUMENT TYPE
   F. MISSING DATA
   G. RULES
   H. PACKET COMPLETION
   I. EXAMPLE USER INTERFACE
   J. EXAMPLE PROCESS
V. IMPLEMENTATION MECHANISMS

### I. Overview

An approach is provided for automated intelligent packet creation based on claims ingestion and validation. Documents may be received and processed from multiple sources. Each received document is analyzed and assigned to one of many packets, each associated with a different claim. Each packet is an instance of a packet profile that identifies a set of required documents. Each packet indicates which of the required documents have been received and which have not yet been received. Rules for a packet dictate how the packet is processed and/or how one or more entities are communicated with in order to retrieve all required documents and their corresponding information. Once a packet is complete, meaning all required documents have been received and are complete, the corresponding claim may be immediately analyzed for claim adjudication and fulfilment.

Embodiments improve computer-related technology, particularly claims processing systems. Traditional claims processing systems merely store and retrieve data for display and manually updating; however, such systems require significant human effort and are prone to substantial delays. Embodiments speed up claim fulfilment and reduce errors by using an automated packet creation approach that allows the claims processing system to keep track of each stage of the claims processing pipeline and automatically generate and receive communications with one or more third parties.

### II. Claims Management Process

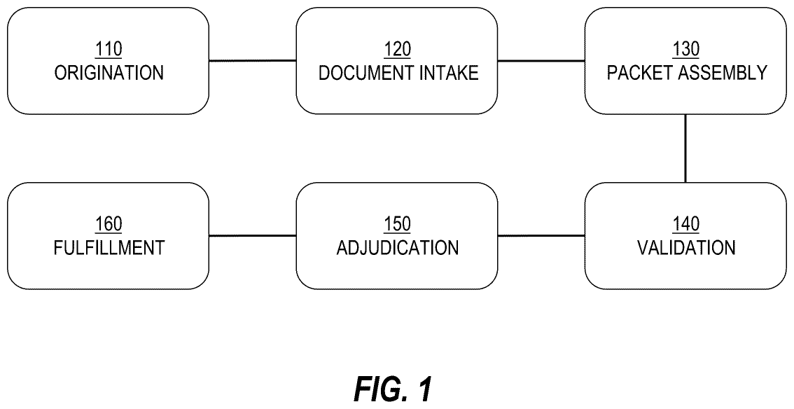

FIG. 1 is a flow diagram that depicts a claims management process 100, in an embodiment. Claims management process 100 includes six processing steps, although there may be more or fewer steps in other embodiments. Also, each step may involve one or more tasks, and each task may comprise multiple sub-tasks. The tasks and sub-tasks vary from claims context to claims context. Example claims contexts include the medical context, the property and casualty (e.g., auto and home) context, and the life and disability context.

The six depicted processing steps include origination 110, document intake 120, packet assembly 130, validation 140, adjudication 150, and fulfillment 160. Origination 110 involves receiving data from a policy holder through one of multiple ways regarding a claim. Example ways through which a claim may originate include:
a. the policy holder submitting a web form through a web page of a website of an enterprise (i.e., the policy providing enterprise) that provides one or more policies to policy holders;
b. the policy holder submitting a claim through a smartphone application provided by the policy providing enterprise;
c. the policy holder submitting a facsimile to a fax machine operated by the policy providing enterprise or a third-party entity that provides claim management process 100;
d. the policy holder submitting one or more physical documents through the postal mail system, arriving at a mail center operated by the policy providing enterprise or the third-party entity; or
e. the policy holder calling a telephone number associated with the policy providing enterprise and a call agent thereof creating an electronic claim through a user interface of the call agent's data system.

Document intake 120 involves receiving and processing documents whose creation is initiated by policy holders, whether the documents come from the policy holders directly or indirectly. For example, a dedicated computer system receives electronic data from web forms through the website or through the smartphone application. As another example, document intake 120 involves scanning documents received through a fax machine and/or through a physical mail service. Scanning documents may involve one or more automated processes, such as optical character recognition (OCR).

Document intake 120 may involve one or more other tasks, such as determining whether a document (whether initially in digital form or converted to a digital form) contains certain information, such as a policy number, a first name, a last name, a mailing address, etc. Certain information may be required to process a document and link the document (or associate it with) the appropriate data record(s) in one or more data systems. Also, different types of documents may have different data requirements. For example, one type of document requires a policy number while another type of document requires a first name, last name, and mailing address. If a document does not contain the required information, then document intake 120 may generate a notification that is sent to the policy holder, such as a notification on a web page that is being presented to the policy holder, an email that includes the policy holder's email address as the destination email address, a text message, or a physical reply mail item.

Packet assembly 130 involves assembling a packet (or group) of documents that are related to a particular claim. Packet assembly 130 involves automatically accessing one or more data systems for each document and identifying one or more records therein. For example, a web form includes a policy holder number and an automated process reads the number, looks up a record in a policy holder database that matches the number, matches information in the web form with information in the retrieved record, creates a new record in a claims database, includes the policy holder number in the new record, creates a new claim identifier and includes the new claim identifier in the new record, and stores information from the web form in the new record. If a document comprises a digital image, then the document may be stored in association with the new (claim) record.

Some packets may require more documents than others. The number and types of documents for each claim may depend on the relevant policy and/or the type of that policy. For example, one auto-related policy may require five documents while another auto-related policy may require six documents, while all life-related policies require just three documents.

A single packet may include documents that are matched to different data systems of the policy providing enterprise. For example, a web form may include a policy holder number and a policy identifier and a matching component uses the policy holder number to identify a first record in a policy holder database and uses the policy identifier to identify a second record in a policy database. If both records are found, then the matching component causes a new record to be created in a claims database, where the new record stores data (e.g., the policy holder number and the policy identifier) that associates the new record with the first and second records.

Validation 140 involves multiple tasks, such as determining whether all documents for a claim pertaining to a particular policy have been received, determining whether data in the documents (e.g., policy identifiers, policy holder numbers, names, addresses) matches corresponding data in records in one or more of the core data systems (such as the policy database, policy holder database, and claims database), determining whether claim request amounts do not exceed policy limits, determining whether a particular policy is out of date, etc. Different policies and different types of policies may have different validation checks.

Adjudication 150 involves one or more tasks to determine whether a claim should be processed fully, partially, or denied altogether. Some governing entities (such as state governments) require licensed individuals to perform such adjudication tasks. Nevertheless, adjudication 150 may involve performing an automatic evaluation of a claim and providing, to a human user, a suggestion based on that evaluation. The human user may view the suggestion along with details of the claim and may accept, decline, or modify the suggestion in order to generate a final adjudication. For example, a task of adjudication 150 may be comparing a repair estimate for a car with the value of the car (e.g., determined automatically by a query to a public database, such as Kelley Blue Book online) where the car is insured by a policy. If the repair estimate is greater than the value of the car, then the automatic evaluation may be to send a check to the policy holder for the value of the car rather than to authorize payment for repair of the car.

Fulfillment 160 involves one or more tasks to communicate with a policy holder. The communication may be a confirmation or a notification that the claim will be fulfilled, partially fulfilled, or declined based on one or more factors. The confirmation/notification may be an email message, a text message, a smartphone application notification, a phone call, and/or a physical mail item. One of the tasks of fulfillment 160 may be electronically sending funds to a financial institution or payment platform associated with the policy holder, such as a bank, Venmo, or Paypal.

In an embodiment, claims management process 100 excludes one or more of these processing steps, such as adjudication 150, which may be performed by an entity that is a third party relative to the policy provider enterprise and to the provider of the claims management system. However, the claims management system may interface with such third party entities by sending and receiving data through secure channels or portals that require authentication and authorization.

### III. Claims Processing System

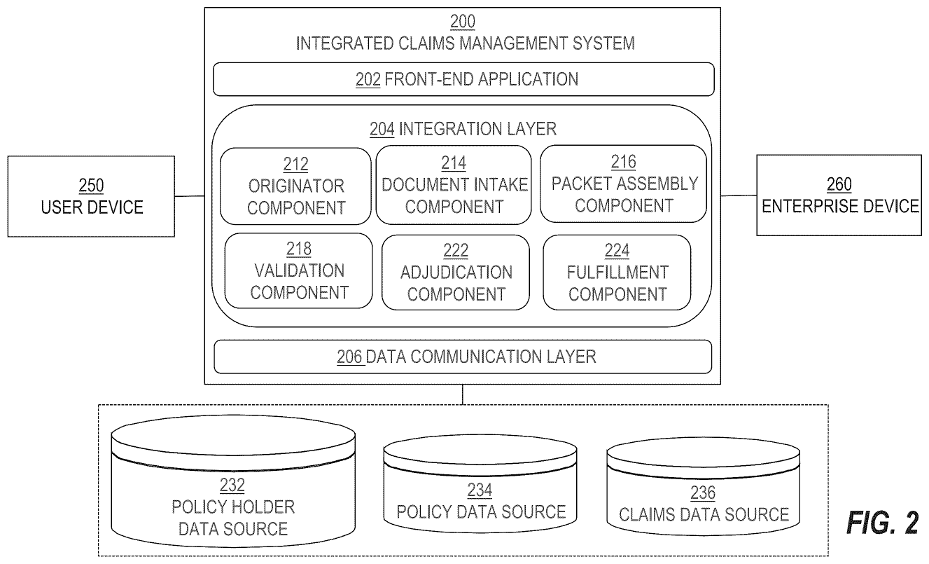

FIG. 2 is a block diagram that depicts an example integrated claims processing system 200, in an embodiment. Integrated claims processing system 200 includes a front-end application 202, an integration layer 204, and a data layer 206, each of which is implemented in software, hardware, or a combination of software and hardware. Each of these components or elements of integrated claims processing system 200 may be implemented on a single computing device or on multiple computing devices that are communicatively coupled to each other. For example, data layer 206 allows components in integration layer 204 to communicate with external data sources 232-236. External data sources 232-236 comprise one or more storage devices that host data pertaining to a particular enterprise and that are separate from one or more computing devices on which integrated claims processing system 200 is hosted.

The enterprise that owns the data stored in the external data sources 232-236 may offer one or more main types of policy coverage: property and casualty (e.g., car, home), medical (e.g., health, dental), and life and disability. The enterprise may offer multiple policies of the same type, such as multiple policies that may be used to cover the same vehicle or multiple policies (related to life coverage) that may be used to cover the same person. Different policies may have different premiums, deductibles, and benefits, including benefit limits.

Front-end application 202 receives, from a user device 250, requests for data stored in data layer 206. A user device 250 is a computing device that is communicatively coupled to integrated claims processing system 200 over a computer network (not depicted). Examples of a computer network include, without limitation, a Local Area Network (LAN), Wide Area Network (WAN), Ethernet, or the Internet, or one or more terrestrial, satellite or wireless links.

Examples of user device 250 include a laptop computer, a desktop computer, a smartphone, and a wearable device. Front-end application 202 may execute as a web server and the requests may be HTTP requests. (Although only a single user device 250 is depicted, multiple user devices may be communicatively coupled to integrated claims processing system 200.) One or more components of integrated claims processing system 200 process such requests and either retrieves data through data layer 206 or generates data to be stored in external data sources 232-236 through data layer 206. User device 250 may send, to integrated claims processing system 200, data about a new claim, data about an existing claim, or a request for data about an existing claim, such as a status of an existing claim or what documents are needed from the user of user device 250 in order for a final decision to be made about a claim.

Front-end application 202 also receives requests from one or more enterprise devices 260-264 that are communicatively coupled to integrated claims processing system 200 over a computer network (e.g., the Internet). Like user device 250, each of enterprise devices 260-264 may be a laptop computer, a desktop computer, a smartphone, or a wearable device. Enterprise devices 260-264 are operated by users of the enterprise that owns the data stored in data layer 206 or provides the policies to end users/customers. Requests from enterprise devices 260-264 may either be to store data in data layer 206 or to retrieve data from data layer 206. Front-end application 202 responds to a request for stored data with data that is rendered by a client application executing on a screen of one of enterprise devices 260-264.

Enterprise devices 260-264 may send, to integrated claims processing system 200, requests for data about an individual claim, data about multiple pending claims that have not yet been assigned to a claim assessor, data about multiple pending claims that have been assigned to a particular claim assessor, data about multiple pending claims that have been assigned to different claim assessors of a particular group, or data about multiple past/pending claims pertaining to a single policy holder. Different enterprise users may have different access rights and, thus, are able to make different types of requests.

Types of enterprise users include managers and claim assessors. A manager oversees a group of multiple claim assessors. A claim assessor is an individual person that has authorized access to information about one or more claims that are assigned to the claim assessor. A claims assessor is able to view attributes of each claim that is assigned to the claims assessor, such as the claim's creation date, information about the originator of the claim, a status of the claim (e.g., whether the claim is fulfilled or pending), a listing of documents that are needed to adjudicate the claim, an indication of which of those documents integrated claims processing system 200 has already received, an indication of which of those documents have not yet been received, a validation status of each received document, a request amount of the claim, etc. Different types of claims may have different sets of attributes, though some attributes may be common to multiple types of claims.

Integration layer 204 includes an originator component 212, a document intake component 214, a packet assembly component 216, a validation component 218, an adjudication component 222, and a fulfillment component 224, each of which is described in more detail herein.

Data layer 206 is communicatively coupled to at least three external data sources 232-236, which may comprise one or more storage devices, such as disk storage, Flash storage, or other persistent storage. External data sources 232-236 may be in a cloud network or may be on-site of the enterprise that provides the policies. Data layer 206 abstracts the communication between integration layer 204 and external data sources 232-236, thus allowing components in integration layer 204 to be composable, i.e., developed independently of how external data sources are implemented, completely agnostic to communication protocols used by external data sources. Thus, data layer 206 is designed with the details of external data sources 232-236 in mind.

Policy holder data source 232 contains data about multiple policy holders, each of which subscribed to a policy provided by the enterprise that owns or manages the data stored in data layer 206. Each record includes data about a policy holder, such as first and last names, mailing address, phone number(s), names and ages of members of the policy holder's family, names or identifiers of one or more policies to which the policy holder is subscribed, a start date of each subscribed-to policy, an end date of each subscribed-to policy, and indication of whether the policy holder has a pending claim for any of the subscribed-to policies.

The names or identifiers of the subscribed-to policies may be primary keys in policy data source 234, which contains data about multiple policies offered by the enterprise. Each record in policy data source 234 includes a name of the corresponding policy, names of documents that the policy requires in order for a claim under the policy to be processed, one or more policy (or benefit) limits (which vary greatly from one type of claim to another), and one or more states in the policy is lawful to be used.

Claims data source 236 contains data about multiple claims. A claim may have one of multiple statuses, such as recently opened, pending, and closed. The pending status may be one of multiple specific statuses, such as pending documents, pending user validation, pending adjudication, and pending fulfillment. A claim also identifies a policy holder (user) using a unique policy holder identifier. A claim also identifies a policy using a unique policy identifier. A claim may indicate which documents have been received and which documents have not yet been received. Example documents include a form from a policy holder, a form from one or more third-party entities (e.g., an approved car repair shop, a doctor's office, a licensed medical professional), a digital image (e.g., of an insured vehicle or house), a phone record from an enterprise user that interacted directly with the policy holder, and a confirmation email from the policy holder.

### IV. Automated Packet Generation

In an embodiment, packet generation is performed automatically and one or more tasks pertaining to packet generation are automated, such as communications with one or more claimants and/or third party entities. While in many scenarios, the claimant and policy holder are the same person, in the health care scenario, they are different. Specifically, the policy holder is the user/customer while the claimant is the healthcare provider, which submits claims to an insurance provider. In this scenario, third parties are communicated with more compared to other insurance scenarios.

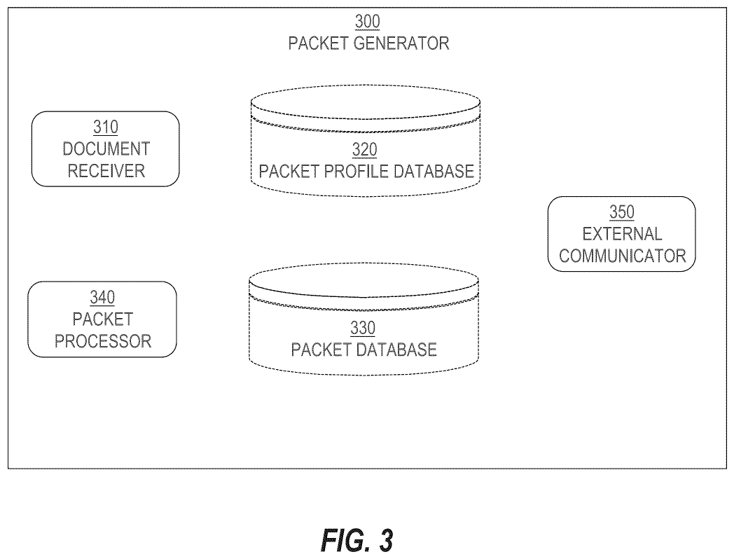

FIG. 3 is a block diagram that depicts components of an example packet generator 300, in an embodiment. Packet generator 300 may perform tasks related to packet assembly 130 and validation 140. Packet generator 300 comprises a document receiver 310, a packet profile database 320, a packet database 330, packet processor 340, and external communicator 350. Packet database 330 may be part of claims data source 236 or may be separate therefrom. For example, each record in claims data source 236 stores (i) a packet (corresponding to a claim) or (ii) a reference to a packet in packet database 330.

Each of document receiver 310, packet processor 340, and external communicator 350 may be implemented in software, hardware, or any combination thereof. Although depicted separately, document receiver 310, packet processor 340, and external communicator 350 may be part of the same program or process. Also, the actions that are described as being performed by each of document receiver 310, packet processor 340, and external communicator 350 may be performed by other components of packet generator 300.

Packet generator 300 may be part of integrated claims processing system 200 or separate therefrom. For example, packet generator 300 may be part of a claims processing system that does not include one or more of the components of integrated claims processing system 200. In either embodiment, packet generator 300 allows for the automatic creation and maintenance of packets, including communications to claimants, policy holders, and/or other third parties to request additional information that, when received from those sources, may be automatically associated with the appropriate packet. In this way, minimal manual intervention is required to collect all documents associated with a claim and trigger a claim adjudication process for that claim. For many claims where there is no missing data and the claimant provides all necessary information, no enterprise user intervention is necessary.

An optical character recognition (OCR) component of claims processing system 200 may perform OCR on an electronic document that system 200 receives. The OCR component may be part of packet generator 300 or separate therefrom. For example, the OCR component may be integrated into document receiver 310. The following description, unless otherwise indicated, assumes that OCR has already been performed on the received electronic document and, therefore, any recognizable text has been extracted (whether field names or field values) and stored in association with the electronic document. Even emails require OCR to extract values and their associated field names.

### A. Document Receiver

Document receiver 310 receives electronic documents from one or more document sources. An electronic document may be submitted directly from a claimant's computing device, such as user device 250, which may be a smartphone, a laptop computer, or a desktop computer. An electronic document may be sent through a web portal, to which the computing device connects over the Internet. Alternatively, an electronic document may be sent in an electronic mail (email) message to an email account associated with the claims processing system 200. Alternatively, an electronic document may be sent from a computing device of a call representative that records, in an electronic record or form, details provided over a telephone by the claimant.

The electronic document may be a web form that the claimant fills out manually with an electronic keyboard and/or using voice-to-text recognition software. The electronic document may be an image that is generated based on scanning a physical document. The physical document may have been scanned by the claimant or may have been received in the mail and opened by a representative (or mail processing assistant) and scanned by the representative. The electronic document may be an image that is generated by a camera that is integrated with (or part of) the claimant's smartphone.

Document receiver 310 (or another component of claims processing system 200) assigns a document identifier (ID) to an electronic document. This document ID is used to uniquely identify the electronic document among all documents that document receiver 310 receives. This document ID may be assigned to the electronic document as metadata throughout the life of the electronic document in claims processing system 200.

### B. Packet

A packet is a group of documents for a claim. In computer memory, a packet may be represented by a data structure, such as an object or a table in a database. For example, each row in a table corresponds to a different document. A packet must be “complete” in order to be considered for claim adjudication. A “complete” packet is one that includes all required documents for the corresponding claim. A required document may be a document is required by law or by internal rules or procedures. A required document may be one of two categories: a “primary document” or a “supporting document.” An FNOL is a required document that may be considered a “primary document” since it may be expected to arrive first for a claim and initiate creation of a claim in one or more data sources, such as claims data source 236. A primary document may designate the type of packet, the type of claim, and/or the type of policy involved. A primary document may also indicate what supporting documents are required.

An example of a supporting document is a police report for automotive claims, which reports are not typically available until 48 hours after the incident. Another example of a supporting document is a death certificate for life insurance claims. A death certificate is typically the last document to be received in a life insurance claim.

A third category of document is a document that is not required by law or internal procedure. Such a document is referred to as an “ancillary document.” An ancillary document may be submitted by a claimant and stored with the packet and, thus, may be considered during claim adjudication. A user may request that an ancillary document be changed to a supporting document for a specific claim, thus altering the packet profile for that claim.

### C. Packet Profile

A packet profile is a data structure that lists a set of required documents for a claim. The list may be a set of document type names and/or identifiers. Each type of policy/claim may have its own packet profile, since different policies require different types of documents. For example, car insurance claims in New York might be associated with one packet profile while car insurance claims in New jersey might be associated with another packet profile. This is possible since different states/regions/jurisdictions have different laws or regulations, which might dictate different required documents and/or different timing requirements. Thus, as described in more detail below, each packet profile may be associated with a different set of rules for processing the packet and/or documents within (or that belong to) the packet.

A packet is an instance of a packet profile. Therefore, a packet inherits the attributes of the packet profile. For example, if a packet profile is associated with one or more rules, then a packet that is generated therefrom is also associated with the one or more rules. Document receiver 310 (or another component of claims processing system 200) generates a packet from a packet profile. Initially, a packet is empty, meaning that the packet is not associated with (e.g., does not include) any documents. Alternatively, creation of a packet may be triggered by receipt of an electronic document for a claim. In this way, a packet initially is associated with (or has) a single document.

A packet lists documents or document types that are not yet included in the packet. As claims processing system 200 receives electronic documents pertaining to a claim, the corresponding packet is updated to remove an indication of those received electronic documents or their corresponding document types.

### D. New Claim Determination

Document receiver 310 receives an electronic document and determines whether the electronic document is for a new claim or an existing claim. A new claim is a claim for which (i) no previous document has yet been received and (ii) no packet has been generated. In some implementations, a new claim will not have any record yet created for it in a claims database. In other implementations, a record for a new claim will already have been created in a claims database, but no packet has been generated.

The determination of whether a claim is new or existing may involve one or more checks. For example, if the electronic document is associated with a claim number (e.g., the claim number is part of the content of the document or is part of the metadata of the document), then the electronic document is for an existing claim. If the electronic document is not associated with a claim number, then it may be determined whether an existing claim exists in a claims database for the claimant in question. This determination may involve document receiver 310 using a policy number and/or a claimant identification data (e.g., a first name and last name) associated with (or on) the electronic document to look up a record in the claims database. A packet ID of a packet may be initially the policy ID of the policy of the corresponding claimant, a claimant ID, or a combination thereof. Alternatively, a packet may be assigned a unique packet ID, which may then be associated with the policy ID, the claimant ID, or a combination thereof. In an embodiment, a unique packet ID is assigned to a claim and used to assemble a packet, and only later provided to a customer's claim management system.

If no pending claim exists for the claimant, then the electronic document is for a new claim. If a pending claim exists for the claimant, then the electronic document is for an existing claim. If multiple pending claims exist for the claimant, then document receiver 310 may assign the electronic document to a packet of a pending claim that has not yet received a document of the type of the electronic document. If multiple pending claims are lacking the document of the type of the electronic document, then a message is generated and transmitted to a representative or administrator of claims processing system 200, the message indicating that claims processing system 200 is unable to automatically assign the electronic document to a pending claim.

If document receiver 310 determines that the electronic document is for a new claim, then selects a packet profile from among multiple packet profiles stored in packet profile database 320. In a scenario where there is only one type of policy or one type of claim, there may be only one packet profile. In scenarios where there are multiple packet profiles in packet profile database 320, selection of the packet profile depends on the type of claim or policy associated with the electronic document. Determination of the type of claim or policy may be based on document identification data that is part of content of the electronic document or part of metadata of the electronic document. Alternatively, the determination of the type of claim/policy is based on the formatting of the electronic document and/or field names in the electronic document.

Document receiver 310 generates a packet from the selected packet profile and stores, in packet database 330, the generated packet and the electronic document in association with the generated packet. Initially, the packet only includes the electronic document. Associating an electronic document with a packet may involve storing the electronic document in a data structure that represents the packet. Alternatively, the packet is updated to include a reference to the electronic document, which may be stored elsewhere, such as in a document data store (not depicted).

If document receiver 310 determines that the electronic document is for an existing claim, then document receiver 310 retrieves a packet in packet database 330. This retrieval may be performed using a claim identifier, which may be a policy identifier (at least initially), or other unique packet identifier. Document receiver 310 updates the packet to associate the electronic document with the packet.

### E. Document Type

Document receiver 310 (or another component of claims processing system 200) determines a document type of the received electronic document. An electronic document may be one of multiple types. An example of a document type is a first notice of loss (FNOL) document. A FNOL document may be the first document that is received for a claim. However, a (primary) FNOL document may be received after another (supporting) document. For example, a claimant may fill out a physical FNOL document and mail the physical FNOL document. While the physical FNOL document is in transit, the claimant emails a (required) supporting document to the entity that manages claims processing system 200. The supporting document is received and processed prior to receipt of the physical FNOL document and the electronic scanning thereof.

In the case where a supporting document is received prior to receipt of a primary document, the supporting document may be assigned a “pending” packet, which is not tied to a particular profile. However, if a supporting document (that is received prior to a primary document) is of a particular document type that is unique to a particular packet profile (i.e., no other packet profile is associated with the supporting document), then the particular packet profile is used to generate the packet and the supporting document is associated with the generated packet.

Different types of claims/policies may require documents of different types. Similarly, different policies of the same type (e.g., car policy) may require documents of different types. The FNOL for a claim of a first type may require different types of information than the FNOL for a claim of a second type that is different than the first type.

The document type may be indicated in metadata of the electronic document. For example, a call representative may have labeled the electronic document as a particular type of document and the label is stored as metadata of the electronic document. As another example, the document type may be explicitly indicated in the electronic document. For example, a physical document that is scanned may include a series of characters that uniquely identify the document type. The series of characters is recognized by an automated optical character recognition (OCR) process. As another example, document receiver 310 automatically infers the document type of an electronic document based on one or more attributes of the electronic document, such as a name of the document, one or more field names in the document, and/or a format of the document. In this latter example, the document type is not explicitly indicated in the electronic document or metadata thereof.

Once the document type of an electronic document is determined, document receiver 310 (or another component) updates the corresponding packet with the electronic document and updates the list of not-yet-received documents by removing the determined document type from the list. For example, if an electronic document is a police report and a corresponding packet lists the police report as not having been received yet, then the corresponding packet is updated to remove the policy report document type from the list.

### F. Missing Data

In some cases, an electronic document may be missing one or more required data values. For example, a first name field on a document may be empty, meaning the corresponding claimant may have forgotten to fill that information in the document. As another example, a signature line may be empty. Document receiver 310 (or another component of claim processing system 200) may detect the missing data values and cause an electronic message to be transmitted to the claimant through one or more communication channels, such as email, text (SMS) message, message to a smartphone application, or automated phone call. This message is transmitted by external communicator 350, which has access to communication options associated with a claimant. Such communication options (e.g., phone number, mobile number, email address, IP address) may be stored in association with the claimant in policy holder data source 232.

In some cases, a required data field includes a value that is not recognizable. For example, the value is handwritten letter or word that an OCR process could not automatically decipher or recognize. In such cases, document receiver 310 (or another component of claims processing system 200) may forward the unrecognizable value to an electronic account or to a computer of a human user, who reviews the value and may manually enter the value via a keyboard or via a voice-to-text input mechanism. If the human user is unable to determine what the value is, then external communicator 350 sends a message to the claimant, which message may include the document and the unrecognizable value.

In some cases, a value in a data field of a document may be invalid, such as a series of numbers in a name field or a series of letters in a social security number field. In such cases, in response to document receiver 310 (or another component) detecting this invalid data, external communicator 350 generates and transmits a message (e.g., email, text message, app message) to the party that provided the document. The message may include an image of the electronic document along with the invalid value, an indication of any other invalid or missing values, and an invitation to provide a valid value in place of the invalid value. The party may operate a computing device to electronically provide a valid value and a response to the message, which document receiver 310 will receive and process accordingly, including identifying the appropriate packet with which the document will be associated along with the valid value.

In some cases, a packet may be missing one or more documents. Packet processor 340 may determine that a packet is missing documents based on analyzing the packet's list of not-yet-received documents. Packet processor 340 may periodically review packets stored in packet database 330 and identify those with one or more missing documents and determine whether contacting the claimant or other party is warranted. For example, each packet (or packet profile) may be associated with a service level agreement (SLA) that dictates how long it should take to fully and/or partially process a claim. For example, different stages of the claims processing pipeline may have different SLAs or different lengths of time. If a time period is about to lapse and a document has not been received, then packet processor 340 may cause external communicator 350 to transmit an electronic message to a party that is expected to supply the document, whether the party is the claimant, or a third party, such as a car repair shop or a medical provider. The message indicates which document is missing and, optionally, includes the (blank) missing document and when a filled out version of the document needs to be returned to claims processing system 200.

In some cases where packet processor 340 identifies a packet with one or more missing documents, packet processor 340 may determine to not notify the expected provider of the one or more missing documents. For example, external communicator 350 may have recently (e.g., in the last two days) transmitted a message to a claimant about a missing document and, therefore, packet processor 340 may wait for another day or two before sending a reminder message to the claimant.

As another example, packet processor 340 determines that there is sufficient time to collect missing documents. Packet processor 340 may access message deadlines that indicate when a message is to be transmitted for a particular missing document. Different documents may be associated with different message deadlines. When the current date matches a message deadline for a document, then packet processor 340 communicates with external communicator 350 to transmit, to the appropriate party, a message that requests the document.

In all these cases of missing documents or missing data, embodiments described herein for automatically communicating with the appropriate parties eliminate human effort and errors from the perspective of claims processing system 200.

### G. Rules

In an embodiment, different rules are associated with different packet profiles and/or document types. Rules may be based on the policy type and/or rules/laws/requirements established by one or more regulatory bodies. Thus, there may be one set of rules for casualty-related claims, another set of rules for health-related claims, and another set of rules for life-related claims. Also, one set of rules may be associated with a packet profile and another set of rules may be associated with a document type within the packet profile. When a packet is generated from a packet profile, the rules associated with the packet profile are associated with the packet. Then, when processing a packet, packet processor 340 analyzes and applies (if applicable) the rules associated with the packet. For example, packet processor 340 processes a rule for missing values or missing documents and uses the rule to determine who to contact, how to contact, and/or when to contact. As another example, a packet may be valid in that the packet includes all required documents, but the claimant's policy is not current. As another example, there may be a data mismatch, such as a first name on one electronic document is “Dan” but the first name in a corresponding record in policy holder data source 232 is “Daniel.”

### H. Packet Completion

When a packet includes or is otherwise associated with all required documents (as defined by the corresponding packet profile), then the packet is “complete” and is ready for claim adjudication, which involves a manual review and, optionally, an automatic review. Packet processor 340 may detect that a packet is complete in one or more ways. For example, when adding an electronic document to a packet, the component performing the addition updates the list of not-yet-received documents and checks to see if there are any required documents remaining in the list. If not, then the packet is complete. As another example, packet processor 340 regularly checks packets (e.g., hourly or daily) to determine whether the status is “complete.” If so, then packet processor 340 updates the packet's status to “awaiting adjudication” and causes a message to be generated.

A packet may be associated with metadata that defines its status as “incomplete,” “complete,” “awaiting adjudication,” “denied,” “partially fulfilled,” and “fulfilled.” When a packet's status is updated to “complete,” packet processor 340 notifies external communicator 350 about the “complete” status and updates the packet's status to “awaiting adjudication.” External communicator 350, in turn, sends a message to one or more entities, such as an administrator of claims processing system 200 or a third-party to claims processing system 200. The message may be sent as an email message, a text message, or a smartphone notification. The message may reference or otherwise indicate a record in a data store that stores records about claims that are ready for adjudication. Selection of the reference may cause the record to be presented on a computing device of the user to whom the message is presented.

### I. Example User Interface

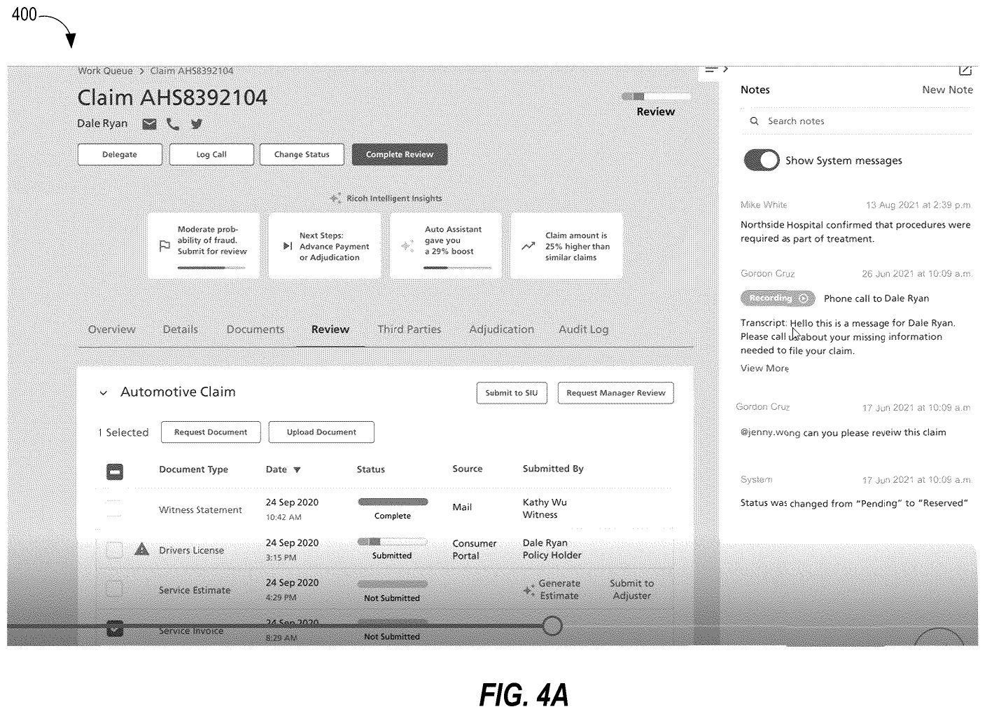

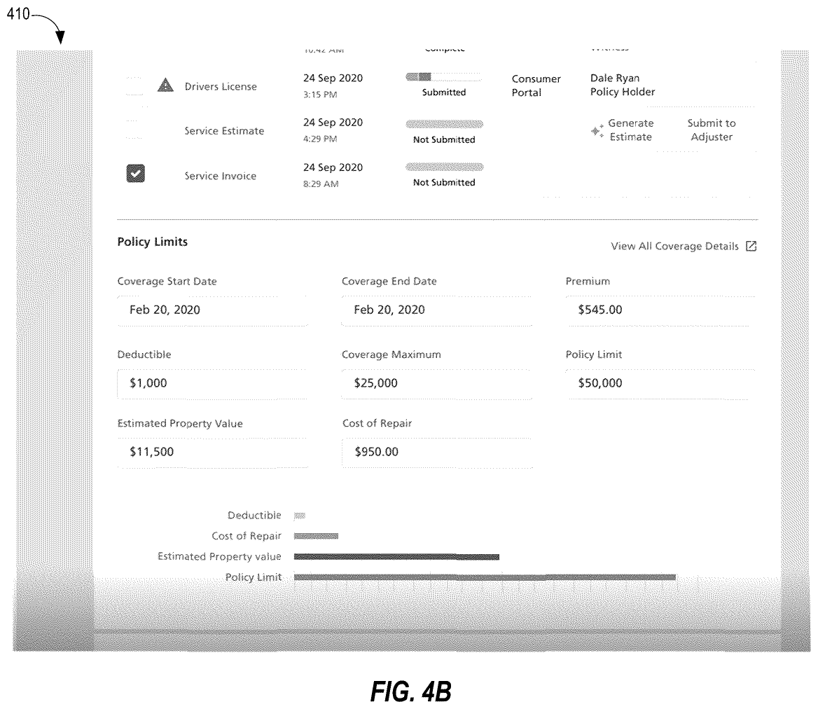

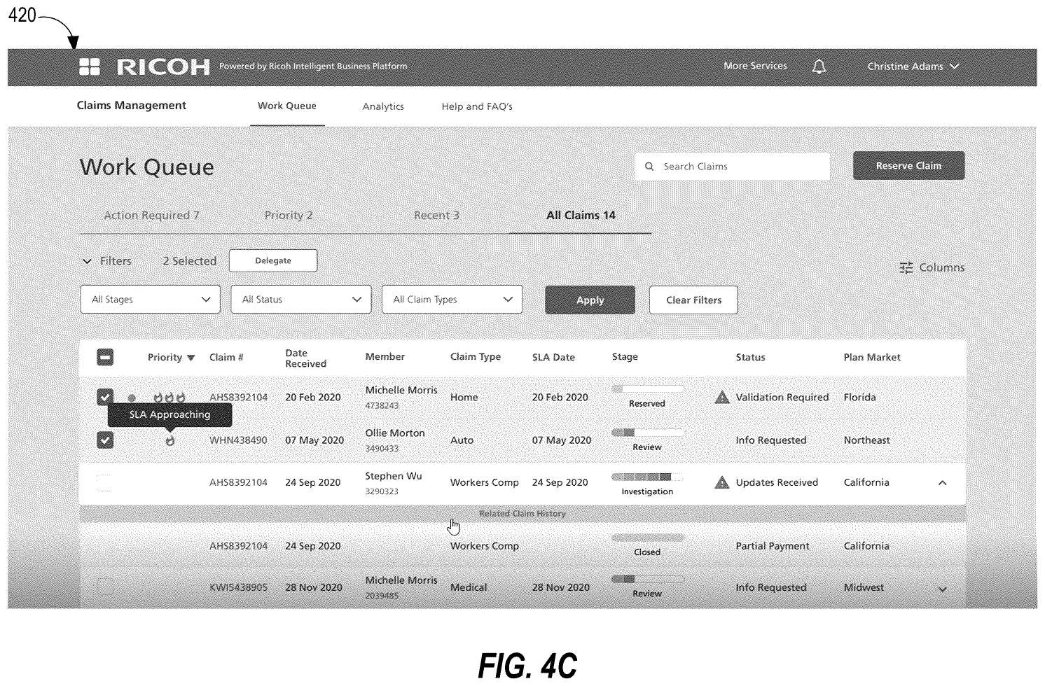

FIGS. 4A-C are screenshots of example user interfaces 400-420 that display information about one or more claims, in an embodiment. These example user interfaces are in the context of automotive claims, but embodiments are not so limited.

User interface 400 lists four documents of a packet that pertains to an automotive claim. Each document is associated with a document type, a date and time in which the document was requested or received, a status of the document (e.g., complete, submitted but not complete, and not submitted), a source or communication channel (e.g., mail, consumer/claimant portal) through which the document was received, and a submitter of the document (e.g., the claimant, a witness, or other third party). A status may be partially complete, meaning that there is missing data associated with the document.

In this example, the drivers license document is associated with a hazard icon, indicating that a potential problem, issue, or anomaly has been automatically identified for the document. There are three main types of anomalies: low confidence readings, database mismatches, and fraud detection (where a machine-learned model may have detected potential fraud with respect to a document based on a training set of past anomalies and non-anomalies).

If a hazard icon adjacent to a document is selected, then a new page or user interface is displayed corresponding to the selected document. The new user interface shows what the problem is, such as a mismatch between (i) the name of the claimant on the document and (ii) the name of the claimant in policy holder data source 232, or a mismatch between (i) a date of an incident on a document and (ii) a date of the incident in claims data source 236. The new user interface may also include a “Confirm Document” button to confirm that there is no major issue, causing the hazard icon on the previous user interface to go away when the previous user interface is displayed and, if applicable, causing a hazard icon on the new user interface to go away (or cease to exist).

In this example, two of the documents have not yet been submitted. Selection of the checkbox adjacent to a particular document followed by a selection of the “Request Document” button will cause an electronic message to be transmitted to a third party (e.g., the claimant, police, service provider) requesting the particular document. If there are multiple documents that are selected, then a single message may be sent if the documents are expected to come from the same party or entity. (The message may identify each of the documents.) Alternatively, a different message may be sent to different parties if the documents are expected to come from different parties. Selection of the checkbox adjacent to a particular document followed by a selection of the “Upload Document” button will cause an option to be displayed that displays one or more windows to allow the user of user interface 400 to identify a document that is stored in a location that is accessible to claims processing system 200 and upload the document to a claims data source so that the document is associated with the automotive claim in question.

FIG. 4B is a screenshot of an example user interface 410 that displays information about the automotive claim, in an embodiment. User interface 410 policy limits associated with the policy under which the automotive claim in user interface 400 is made. Because a claim is tied to a specific policy, the automotive claim is associated with a policy number and the policy number identifies a record, in policy data source 234, that includes these policy limits. Thus, the policy limits may come from policy data source 234.

FIG. 4C is a screenshot of an example user interface 420 that allows an enterprise user to view multiple claims, in an embodiment. The multiple claims may be assigned to the same enterprise user. Alternatively, the multiple claims may be assigned to a group of users. For each claim, user interface 420 displays a priority of the claim, an ID of the claim, a date the claim was received or created, a name of the claimant, a claim type, an SLA date (or date in which a response is required), a stage of the claim (e.g., reserved, under review, under investigation, closed), a status of the claim (e.g., awaiting document, paid in full, approved for repair, rejected), and a plan market or region of the claim.

### J. Example Process

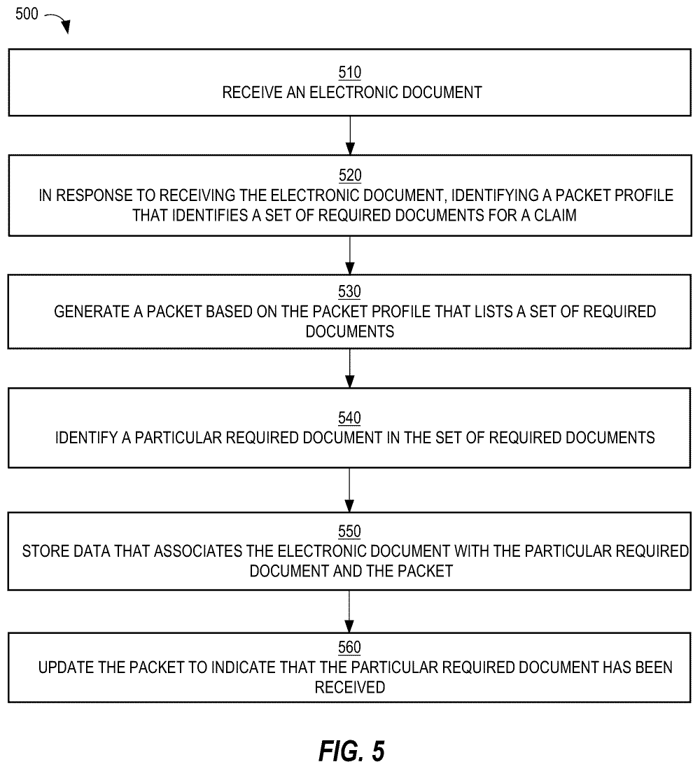

FIG. 5 is a flow diagram that depicts an example process 500 for processing an electronic document during a claims management process, in an embodiment. Process 500 may be performed by different components of packet generator 300.

At block 510, an electronic document is received. Block 510 may be performed by document receiver 310. The electronic document may have been an electronic document originally or may be a scanned document or an image taken from a physical document.

At block 520, in response to receiving the electronic document, a packet profile that identifies a set of required documents for a claim is identified. Block 520 may involve selecting the packet profile from among multiple packet profiles, if multiple packet profiles exist. Block 520 may have been preceded by a determination that the electronic document is for a new claim, is for a primary document, or is not related to any other pending claim.

At block 530, a packet is generated based on the packet profile. The packet is considered “empty” initially and is associated with any metadata of the packet profile, such as a list of required documents, one or more timelines when required documents should be received, and/or one or more rules that pertain to the packet profile or the associated policy. Block 530 may involve making an editable copy of the packet profile and storing the creation date and/or time in association with the packet.

At block 540, a particular required document in the list of required documents is identified. Block 540 may involve determining a document type of the received electronic document and then comparing the document type with the document type of each required document in the list of required documents until a match is found.

At block 550, data that associates the electronic document with the particular required document and the packet is stored. Block 550 may involve generating and storing (i) document metadata that labels the electronic document as the particular required document and (ii) packet metadata that identifies or references the electronic document.

At block 560, the packet is updated to indicate that the particular required document has been received. The packet continues to indicate that one or more required documents, in the set of required documents, that are different than the particular required document, have not been received.

### V. Implementation Mechanisms

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

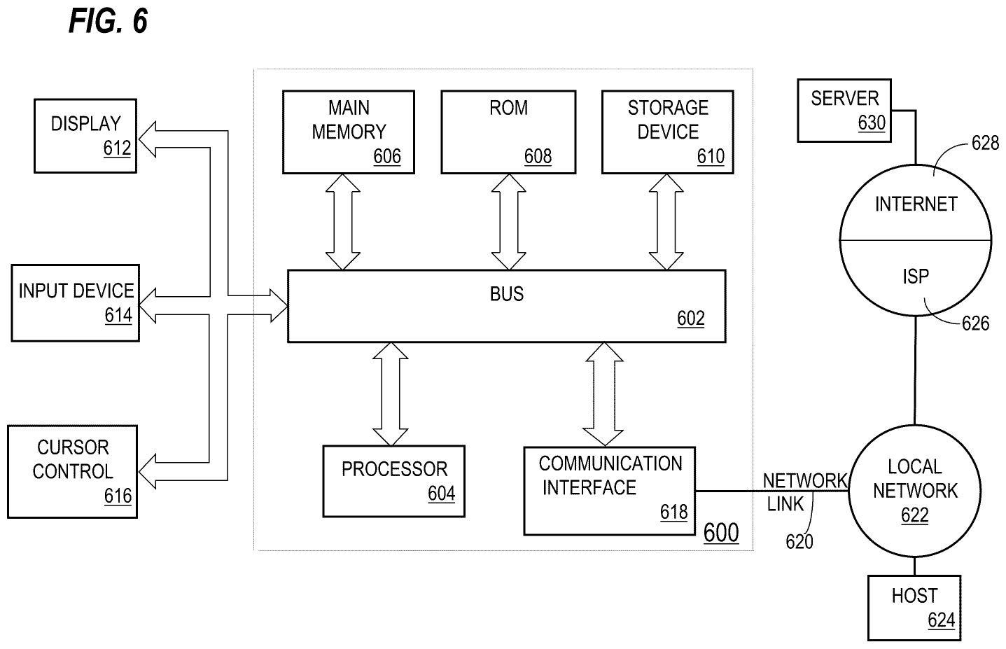

FIG. 6 is a block diagram that depicts an example computer system 600 upon which embodiments of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. Although bus 602 is illustrated as a single bus, bus 602 may comprise one or more buses. For example, bus 602 may include without limitation a control bus by which processor 604 controls other devices within computer system 600, an address bus by which processor 604 specifies memory locations of instructions for execution, or any other type of bus for transferring data or signals between components of computer system 600.

An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic or computer software which, in combination with the computer system, causes or programs computer system 600 to be a special-purpose machine. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operate in a specific manner. In an embodiment implemented using computer system 600, various computer-readable media are involved, for example, in providing instructions to processor 604 for execution. Such a medium may take many forms, including but not limited to, non-volatile media and volatile media. Non-volatile media includes, for example, optical or magnetic disks, such as storage device 610. Volatile media includes dynamic memory, such as main memory 606. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising:
one or more processors;
a memory storing instructions which, when executed by the one or more processors, cause, automatically:
receiving an indication of a receipt of a document;
in response to receiving the indication, identifying a packet profile that identifies a set of required documents for a claim;
generating a packet based on the packet profile;
identifying a particular required document in the set of required documents;
storing data that associates the document with the particular required document and the packet;
updating the packet to indicate that the particular required document has been received, wherein the packet indicates that one or more required documents, in the set of required documents, that are different than the particular required document, have not been received.

2. The apparatus of claim 1, wherein the instructions, when executed by the one or more processors, further cause:
in response to receiving the indication, identifying a claim type, from among a plurality of claim types;
wherein each claim type of the plurality of claim types is associated with a different packet profile of a plurality of packet profiles;
wherein a first packet profile in the plurality of packet profiles identifies a first set of required documents;
wherein a second packet profile in the plurality of packet profiles identifies a second set of required documents that is different than the first set of required documents;
wherein identifying the packet profile comprises identifying the packet profile, from among the plurality of packet profiles, based on the claim type.

3. The apparatus of claim 1, wherein:
the packet profile is a first packet profile;
the plurality of packet profiles includes the first packet profile and a second packet profile that is different than the first packet profile;
the first packet profile is associated with a first set of one or more rules and the second packet profile is associated with a second set of one or more rules that are not associated with the first packet profile;
the instructions, when executed by the one or more processors, further cause:
based on the packet being generated based on the first packet profile, processing the first set of one or more rules and not the second set of one or more rules.

4. The apparatus of claim 3, wherein:
the first set of one or more rules are based on a first regulatory jurisdiction and the second set of one or more rules are based on a second regulatory jurisdiction that is different than the first regulatory jurisdiction; or
the first set of one or more rules are based on the first packet profile being associated with a first type of claim and the second set of one or more rules are based on the second packet profile being associated with a second type of claim that is different than the first type of claim.

5. The apparatus of claim 1, wherein the instructions, when executed by the one or more processors, further cause:
determining whether certain data associated with the packet is missing;
in response to determining that the certain data is missing, causing a message to be transmitted to a computing device or account of an entity that is different than the entity that operates the apparatus, wherein the message indicates that the certain data is missing and invites the entity to provide the certain data.

6. The apparatus of claim 1, wherein the instructions, when executed by the one or more processors, further cause:
determining that the packet is associated with a second document;
determining whether the second document is missing a required data item;
in response to determining that the second document is missing one or more required data items, causing a message to be transmitted to a computing device of user that is associated with the claim, wherein the message identifies the one or more required data items, indicates that the one or more required data items are missing, and invites the user to provide the one or more required data items.

7. The apparatus of claim 1, wherein the document is a first document, wherein the packet is one of a plurality of packets, wherein the instructions, when executed by the one or more processors, further cause, after updating the packet to indicate that the particular required document has been received:
receiving a second indication of a receipt of a second document;
in response to receiving the second indication, determining that the second document pertains to the packet and no other packet of the plurality of packets;
identifying a second required document in the set of required documents;
storing second data that associates the second document with the second required document and the packet;
updating the packet to indicate that the second required document has been received, wherein the packet indicates that one or more second required documents, in the set of required documents, that are different than the particular required document and the second required document, have not been received.

8. The apparatus of claim 1, wherein the instructions, when executed by the one or more processors, further cause:
receiving a second indication of a receipt of a second document;
in response to receiving the second indication, determining that the second document pertains to the packet and no other packet of the plurality of packets;
determining that the second document is not one of the required documents in the set of required documents for the packet;
storing second data that associates the second document with the packet and that indicates that the second document is an ancillary document in the packet.

9. The apparatus of claim 1, wherein the instructions, when executed by the one or more processors, further cause:
receiving the document through email, through a web portal, or based on scanning a physical document that was received as physical mail.

10. One or more storage media storing instructions which, when executed by one or more processors, cause:
receiving an indication of a receipt of a document;
in response to receiving the indication, identifying a packet profile that identifies a set of required documents for a claim;
generating a packet based on the packet profile;
identifying a particular required document in the set of required documents;
storing data that associates the document with the particular required document and the packet;
updating the packet to indicate that the particular required document has been received, wherein the packet indicates that one or more required documents, in the set of required documents, that are different than the particular required document, have not been received.

11. The one or more storage media of claim 10, wherein the instructions, when executed by the one or more processors, further cause:
in response to receiving the indication, identifying a claim type, from among a plurality of claim types;
wherein each claim type of the plurality of claim types is associated with a different packet profile of a plurality of packet profiles;
wherein a first packet profile in the plurality of packet profiles identifies a first set of required documents;
wherein a second packet profile in the plurality of packet profiles identifies a second set of required documents that is different than the first set of required documents;
wherein identifying the packet profile comprises identifying the packet profile, from among the plurality of packet profiles, based on the claim type.

12. The one or more storage media of claim 10, wherein:
the packet profile is a first packet profile;
the plurality of packet profiles includes the first packet profile and a second packet profile that is different than the first packet profile;
the first packet profile is associated with a first set of one or more rules and the second packet profile is associated with a second set of one or more rules that are not associated with the first packet profile;
the instructions, when executed by the one or more processors, further cause:
based on the packet being generated based on the first packet profile, processing the first set of one or more rules and not the second set of one or more rules.

13. The one or more storage media of claim 12, wherein:
the first set of one or more rules are based on a first regulatory jurisdiction and the second set of one or more rules are based on a second regulatory jurisdiction that is different than the first regulatory jurisdiction; or
the first set of one or more rules are based on the first packet profile being associated with a first type of claim and the second set of one or more rules are based on the second packet profile being associated with a second type of claim that is different than the first type of claim.

14. The one or more storage media of claim 10, wherein the instructions, when executed by the one or more processors, further cause:
determining whether certain data associated with the packet is missing;
in response to determining that the certain data is missing, causing a message to be transmitted to a computing device or account of an entity that is different than the entity that operates the apparatus, wherein the message indicates that the certain data is missing and invites the entity to provide the certain data.

15. The one or more storage media of claim 10, wherein the instructions, when executed by the one or more processors, further cause:
determining that the packet is associated with a second document;
determining whether the second document is missing a required data item;
in response to determining that the second document is missing one or more required data items, causing a message to be transmitted to a computing device of user that is associated with the claim, wherein the message identifies the one or more required data items, indicates that the one or more required data items are missing, and invites the user to provide the one or more required data items.

16. The one or more storage media of claim 10, wherein the document is a first document, wherein the packet is one of a plurality of packets, wherein the instructions, when executed by the one or more processors, further cause, after updating the packet to indicate that the particular required document has been received:
receiving a second indication of a receipt of a second document;
in response to receiving the second indication, determining that the second document pertains to the packet and no other packet of the plurality of packets;
identifying a second required document in the set of required documents;
storing second data that associates the second document with the second required document and the packet;
updating the packet to indicate that the second required document has been received, wherein the packet indicates that one or more second required documents, in the set of required documents, that are different than the particular required document and the second required document, have not been received.

17. The one or more storage media of claim 10, wherein the instructions, when executed by the one or more processors, further cause:
receiving a second indication of a receipt of a second document;
in response to receiving the second indication, determining that the second document pertains to the packet and no other packet of the plurality of packets;
determining that the second document is not one of the required documents in the set of required documents for the packet;
storing second data that associates the second document with the packet and that indicates that the second document is an ancillary document in the packet.

18. The one or more storage media of claim 10, wherein the instructions, when executed by the one or more processors, further cause:
receiving the document through email, through a web portal, or based on scanning a physical document that was received as physical mail.

19. A method comprising:
receiving an indication of a receipt of a document;
in response to receiving the indication, identifying a packet profile that identifies a set of required documents for a claim;
generating a packet based on the packet profile;
identifying a particular required document in the set of required documents;
storing data that associates the document with the particular required document and the packet;
updating the packet to indicate that the particular required document has been received, wherein the packet indicates that one or more required documents, in the set of required documents, that are different than the particular required document, have not been received.

20. The method of claim 19, further comprising:
in response to receiving the indication, identifying a claim type, from among a plurality of claim types;
wherein each claim type of the plurality of claim types is associated with a different packet profile of a plurality of packet profiles;
wherein a first packet profile in the plurality of packet profiles identifies a first set of required documents;
wherein a second packet profile in the plurality of packet profiles identifies a second set of required documents that is different than the first set of required documents;
wherein identifying the packet profile comprises identifying the packet profile, from among the plurality of packet profiles, based on the claim type.
